(19) United States
(12) Patent Application Publication
(10) Pub. No.: US 2026/0308771 A1
(43) Pub. Date: Oct. 8, 2026

(54) AMMONIA CRACKER

(71) Applicants: Nanyang Technological University, Singapore (SG); THE CHANCELLOR, MASTERS AND SCHOLARS OF THE UNIVERSITY OF CAMBRIDGE, Cambridge (GB)

(72) Inventors: Chencheng DAI, Singapore (SG); Zhichuan XU, Singapore (SG); Adrian Charles FISHER, Cambridge (GB); Kamal ELOUARZAKI, Singapore (SG)

(21) Appl. No.: 19/483,446

(22) PCT Filed: May 10, 2024
(86) PCT No.: PCT/SG2024/050308

§ 371 Date: Nov. 11, 2025

(30) Foreign Application Priority Data
May 12, 2023 (SG) 10202301326Y

(51) Int. Cl. C25B 1/02; C25B 9/23; C25B 11/052; C25B 11/054; C25B 11/056; C25B 11/063; C25B 11/065; C25B 11/081; C25B 15/08

(52) U.S. Cl. CPC C25B 1/02; C25B 9/23; C25B 11/052; C25B 11/054; C25B 11/056; C25B 11/063; C25B 11/065; C25B 11/081; C25B 15/08

(57) ABSTRACT

Provided herein is an ammonia cracker comprising: an anolyte reservoir housing an anolyte comprising alkali and ammonia; at least one catholyte reservoir housing at least one catholyte, wherein the at least one catholyte comprises acid or alkali; and an electrolysis cell, the electrolysis cell comprising: an anode chamber housing an anode; at least one cathode chamber housing a cathode; and an ion exchange membrane separating the anode chamber and the cathode chamber. Also provided herein is a method of producing hydrogen, the method comprising: (i) feeding an anolyte comprising ammonia and alkali to an anode chamber housing an anode; and (ii) feeding an acid or alkali catholyte to a cathode chamber housing a cathode; wherein an ion exchange membrane separates the anode chamber and the cathode chamber. Further provided herein is hydrogen produced by the method disclosed herein.

### TECHNICAL FIELD

The present invention generally relates to ammonia crackers. In particular, the present invention relates to ammonia crackers utilizing acids and/or alkalis as catholyte.

### BACKGROUND ART

Hydrogen is a zero-carbon emission chemical fuel which is both a promising alternative to fossil fuels and an ideal solution to the global climate crisis. However, due to the extreme difficulties in storage, transportation and handling of hydrogen, using a hydrogen vector in place of hydrogen during these processes has been floated as a possible alternative to overcome the difficulties. Accordingly, ammonia has considered as a potential hydrogen vector as well as energy source for the following reasons: (1) Ammonia may be liquefied at a far lower pressure (8.6 bar) at room temperature as compared to hydrogen (700 bars), thus reducing the cost of storage and transportation; (2) Liquid ammonia has three times higher volumetric energy density than that of liquid hydrogen; (3) Ammonia contains 17.8 wt % hydrogen, far higher than other fuels such as methanol (12.5 wt %) or ethanol (13.0 wt %); and (4) Ammonia is the second largest commodity chemical worldwide and thus there are facilities existing worldwide to store, transport and handle ammonia.

However, conventionally, the extraction of hydrogen from ammonia is mainly carried out by thermal catalytic cracking which requires cither expensive Ru with high operating temperatures of 400° C., or cheaper Ni-based catalysts but at even higher operating temperatures between 500° C. to 600° C. Furthermore, hydrogen used in downstream applications such as polymer electrolyte membrane fuel cells (PEMFC) must be highly purified, and hence great effort needs to be made to separate and purify the hydrogen from the side-products during thermal cracking of ammonia.

There is a need to provide ammonia crackers that overcome, or at least ameliorate, one or more of the disadvantages described above.

### SUMMARY

In an aspect of the present disclosure, there is provided an ammonia cracker comprising:
an anolyte chamber housing an anolyte, wherein the anolyte comprises alkali and ammonia;
a first catholyte chamber housing a first catholyte, wherein the first catholyte comprises alkali;
a second catholyte chamber housing a second catholyte, wherein the second catholyte comprises acid; and
an electrochemical cracking cell, comprising:
   an anode chamber housing an anode;
   a cathode chamber housing a cathode; and
   an ion exchange membrane separating the anode chamber and the cathode chamber.

In another aspect of the present disclosure, there is provided an ammonia cracker comprising:
an anolyte chamber housing an anolyte, wherein the anolyte comprises alkali and ammonia;
a catholyte chamber housing an acid catholyte; and
an electrolysis cell, the electrolysis cell comprising:
   an anode chamber housing an anode;
   a cathode chamber housing a cathode; and
   an ion exchange membrane separating the anode chamber and the cathode chamber.

In a further aspect of the present disclosure, there is provided an ammonia cracker comprising:
an anolyte chamber housing an anolyte, wherein the anolyte comprises alkali and ammonia;
a catholyte chamber housing an alkali catholyte; and
an electrolysis cell, the electrolysis cell comprising:
   an anode chamber housing an anode;
   a cathode chamber housing a cathode; and
   an ion exchange membrane separating the anode chamber and the cathode chamber.

The ammonia cracker of the present disclosure is advantageously capable of cracking ammonia at a low cell potential while maintaining sufficient current density required for industrial needs. More advantageously, the presently disclosed ammonia cracker may have zero greenhouse gas emissions and may not require high operating temperatures nor operating pressures.

The ammonia cracker of the present disclosure may possess an advantageously high energy efficiency due to the high current density and the corresponding low cell potential at low temperature and ambient pressure.

Nitrogen (with residual ammonia) may be advantageously generated separately from gaseous hydrogen at the anode and cathode respectively. Further, as the anode and cathode chambers are separated from each other, there is no mixing of the outlet gases, and thus gaseous hydrogen may be advantageously obtained at high yield and purity without need for further purification, thus advantageously simplifying downstream processes and costs.

Advantageously, the ammonia crackers of the present disclosure may be easily stacked and scaled up to meet on-demand and on-site hydrogen production needs as required.

In another aspect of the present disclosure, there is provided a method of producing hydrogen, the method comprising:
(i) feeding an anolyte comprising ammonia and alkali to an anode chamber housing an anode;
(ii) feeding an alkali catholyte to a cathode chamber housing a cathode; and
(iii) applying an electric potential between the anode and the cathode to activate electrolysis,
wherein an ion exchange membrane separates the anode chamber and the cathode chamber.

In a further aspect of the present disclosure, there is provided a method of producing hydrogen, the method comprising:
(i) feeding an anolyte comprising ammonia and alkali to an anode chamber housing an anode; and
(ii) feeding an acid catholyte to a cathode chamber housing a cathode,
wherein an ion exchange membrane separates the anode chamber and the cathode chamber.

In another aspect of the present disclosure, there is provided a method of producing hydrogen, the method comprising:
(i) feeding an anolyte comprising ammonia and alkali to an anode chamber housing an anode;
(ii) feeding a first catholyte to a cathode chamber housing a cathode, wherein the first catholyte comprises alkali;
(iii) applying an electric potential between the anode and the cathode to activate electrolysis; and
(iv) switching from feeding a first catholyte to the cathode chamber to feeding a second catholyte to the cathode chamber after a predetermined period of time, wherein the second catholyte comprises acid,
wherein an ion exchange membrane separates the anode chamber and the cathode chamber.

Advantageously, this configuration allows for the switching between alkali catholyte and acid catholyte to the cathode chamber (and vice versa). By switching from alkali catholyte to an acid catholyte, the ammonia cracker of the present disclosure can generate both electricity and hydrogen concurrently. By switching to an acid catholyte, the electric potential needed to electrolyze ammonia is lower as compared to when an alkali catholyte is used, and thus advantageously saves on electricity and electricity bills, particularly during periods where electricity tariffs are higher. On the other hand, when switching to an alkali catholyte, the ammonia cracker of the present disclosure may require electricity to electrolyze ammonia and generate hydrogen, but can generate hydrogen at a far higher rate as compared to when an acid catholyte is used. Advantageously, the ammonia cracker can switch to an alkali catholyte to generate hydrogen when tariffs are low, and advantageously switch to an acid catholyte to still generate hydrogen without consuming any electricity when electricity tariffs are high.

In a further aspect of the present disclosure, there is provided hydrogen produced by the methods disclosed herein.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

The word “substantially” does not exclude “completely” e.g. a composition which is “substantially free” from Y may be completely free from Y. Where necessary, the word “substantially” may be omitted from the definition of the invention.

As used herein, the terms “cracker”, “electrical cracker”, “electrochemical cracker”, or “e-cracker” refers to a system that utilizes electrochemical energy to crack compounds, or ammonia as in the present disclosure.

As used herein, the term “pulsed electric potential” refers to an applied electrical potential that is not constant over time. The pulsed electric potential applied may be a stepped or sinusoidal waveform, as long as the average potential applied remains constant over time.

As used herein, the term “fluidly connected” refers to means to transport a fluid from one chamber to another chamber, optionally via one or more intervening components or units. The fluid connection may therefore be direct or indirect.

As used herein, the term “alkali-alkali” refers to an ammonia cracker comprising alkali catholyte and alkali anolyte.

As used herein, the term “acid-alkali” refers to an ammonia cracker comprising acidic catholyte and alkali anolyte.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, arc intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

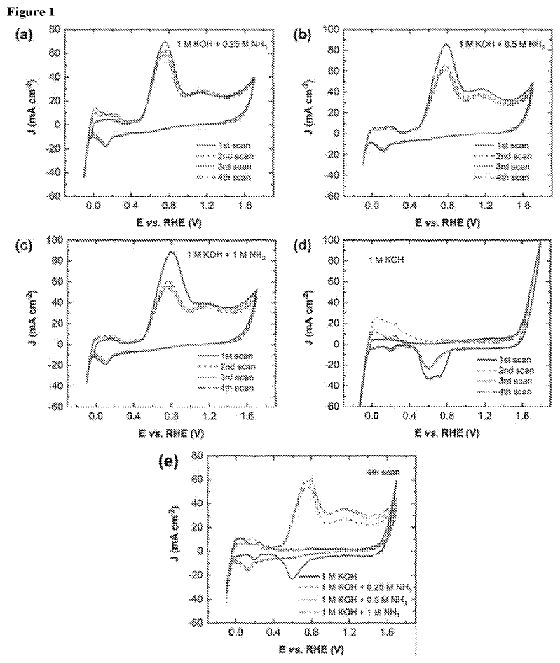

### FIG. 1

FIG. 1 is a diagram showing Cyclic Voltammetry (CV) curves of the Ammonia Oxidation Reaction (AOR) at varying NH₃ concentrations ((a), (b), (c), and (d)), with (e) showing the stacked graphs of the 4th scans of the same CV curves at the various NH₃ concentrations. 40 wt % Pt/C on GCE was used as catalyst with the anolyte further comprising 1 M KOH.

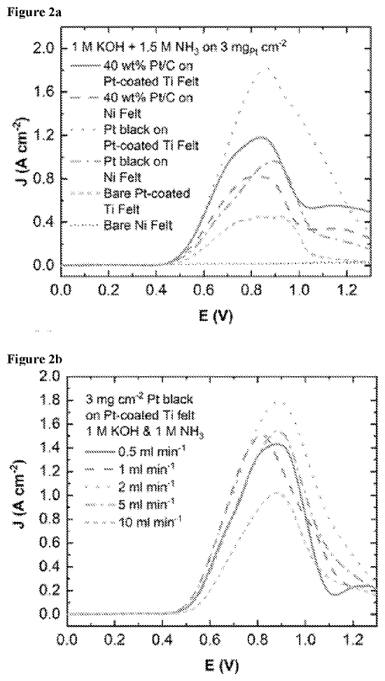

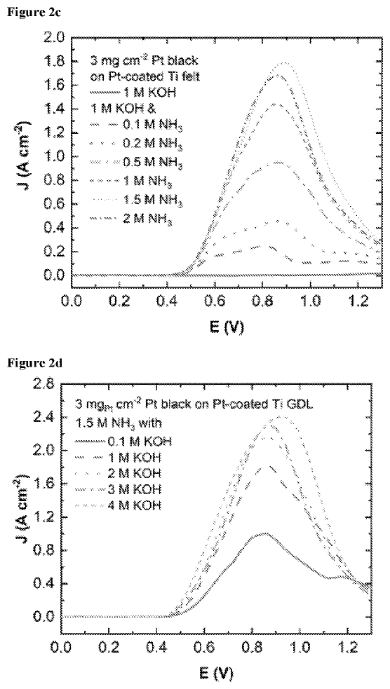

### FIG. 2a

FIG. 2a is a set of Linear Sweep Voltammetry (LSV) curves of AOR with various anode GDE components. 3 mg cm⁻² loading was used, while 1.5 M NH₃ in 1 M KOH was used as anolyte, and the tests were performed at 80° C.

### FIG. 2b

FIG. 2b is a set of LSV curves of AOR at various anolyte flow rates. 3 mg cm⁻² Pt black on Pt-coated Ti felt was used, 1.5 M NH₃ in 1 M KOH was used as anolyte, and the tests were performed at 80° C.

### FIG. 2c

FIG. 2c is a set of LSV curves of AOR at varying ammonia concentrations. 3 mg cm⁻² Pt black on Pt-coated Ti felt was used, with the anolyte further comprising 1 M KOH with a flow rate of 2 ml min⁻¹, and the tests were performed at 80° C.

### FIG. 2d

FIG. 2d is a set of LSV curves of AOR at varying KOH concentrations. 3 mg cm⁻² Pt black on Pt-coated Ti felt was used, with the anolyte further comprising 1.5 M NH₃ with a flow rate of 2 ml min⁻¹, and the tests were performed at 80° C.

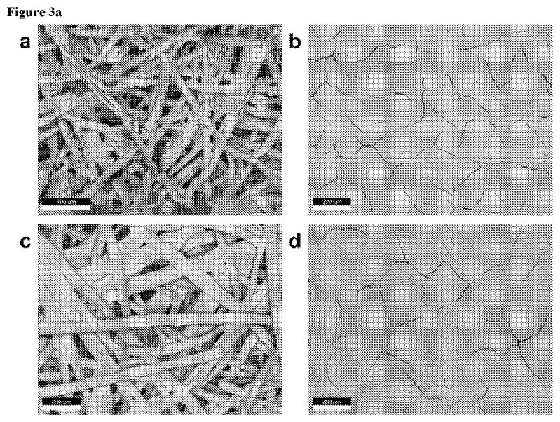

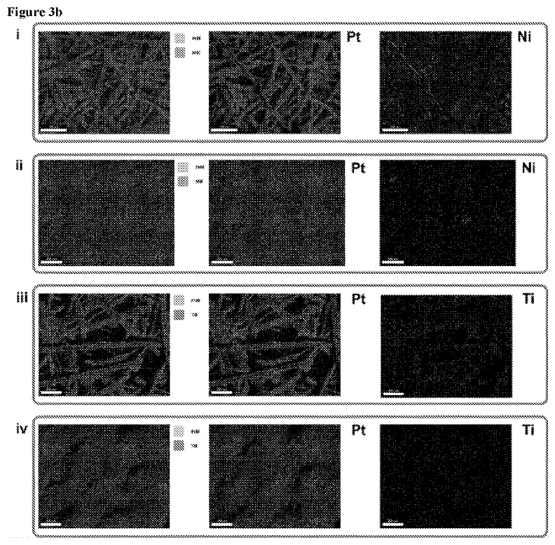

### FIG. 3a

FIG. 3a is a set of Scanning Electron Microscopy (SEM) images of 3 mgₚₜ cm⁻² (a) Pt black on Ni felt; (b) 40 wt % Pt/C on Ni felt; (c) Pt black on Pt-coated Ti felt; and (d) 40 wt % Pt/C on Pt-coated Ti felt.

### FIG. 3b

FIG. 3b is a set of Energy-dispersive X-ray spectroscopy (EDX) images of 3 mgₚₜ cm⁻² (i) Pt black on Ni felt; (ii) 40 wt % Pt/C on Ni felt; (iii) Pt black on Pt-coated Ti felt; and (iv) 40 wt % Pt/C on Pt-coated Ti felt.

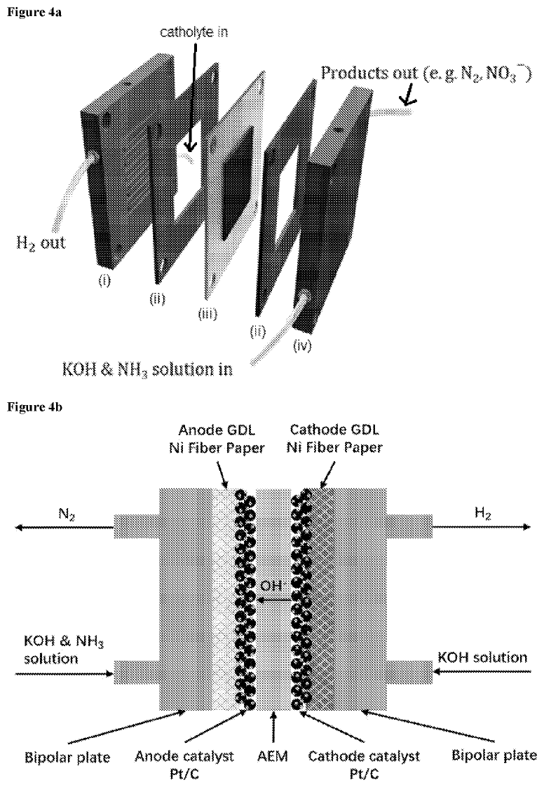

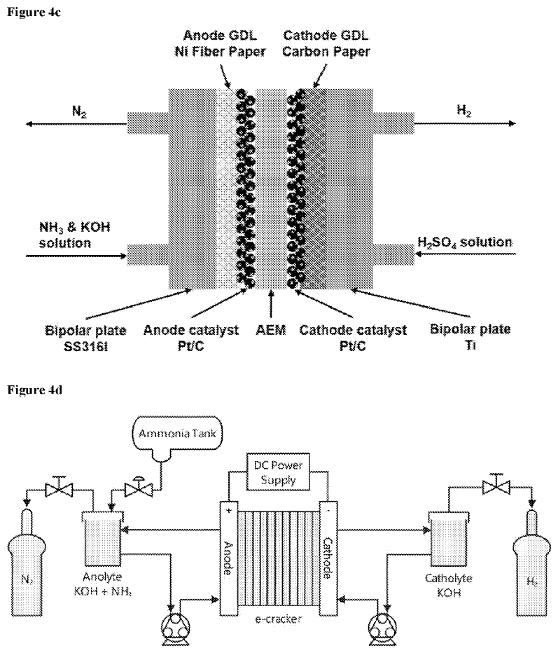

### FIG. 4a

FIG. 4a is a schematic of a representative ammonia cracker cell of the present invention for AOR, with the following components from left to right: (i) cathode bipolar plate; (ii) gaskets; (iii) membrane electrode assembly; and (iv) anode bipolar plate.

### FIG. 4b

FIG. 4b shows the cross-sectional configuration of the ammonia cracker cell of FIG. 4a when an alkali catholyte is used.

### FIG. 4c

FIG. 4c shows the cross-sectional configuration of the ammonia cracker cell of FIG. 4a when an acid catholyte is used.

### FIG. 4d

FIG. 4d is a schematic of an alkali-alkali ammonia cracker of the present invention for electrochemical AOR.

### FIG. 4c

FIG. 4e is a schematic of an ammonia cracker of the present invention for electrochemical AOR using acidic (H₂SO₄) catholyte.

### FIG. 4f

FIG. 4f is a schematic of an ammonia cracker of the present invention comprising two catholyte chambers, one catholyte chamber housing an alkali (KOH) catholyte, and the other catholyte chamber housing an acidic (H₂SO₄) catholyte.

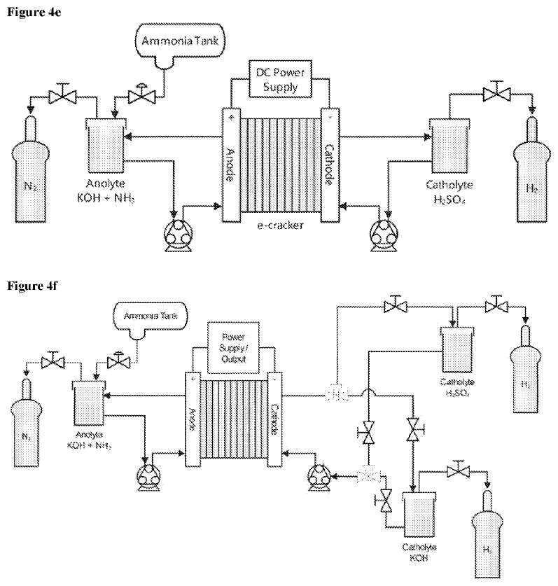

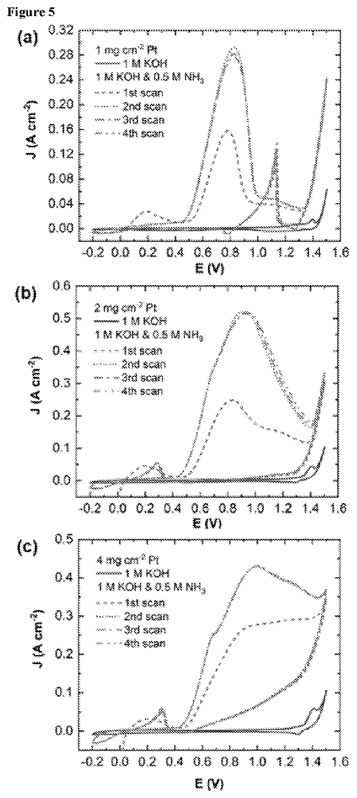

### FIG. 5

FIG. 5 is a set of CV curves of an alkali-alkali ammonia cracker at varying Pt loading. 0.5M NH₃ in 1 M KOH was used as anolyte.

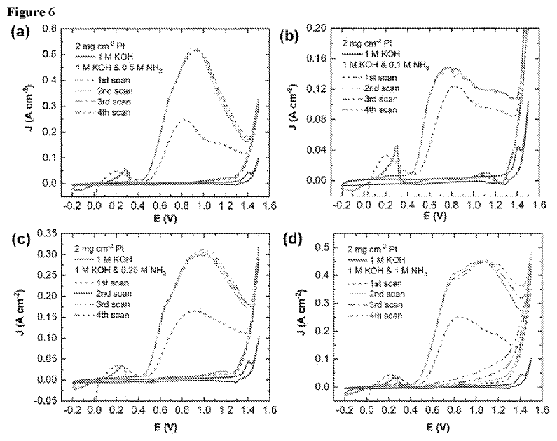

### FIG. 6

FIG. 6 is a set of CV curves of an alkali-alkali ammonia cracker at varying NH₃ concentrations. Pt loading of 2 mg cm⁻² was used, with the anolyte further comprising 1 M KOH.

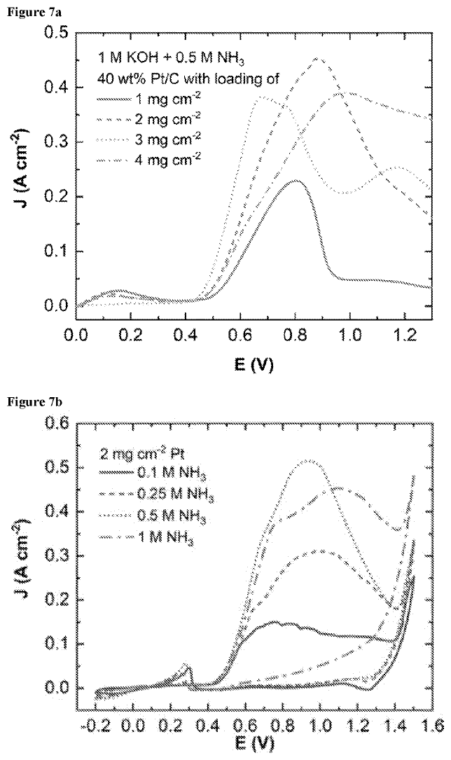

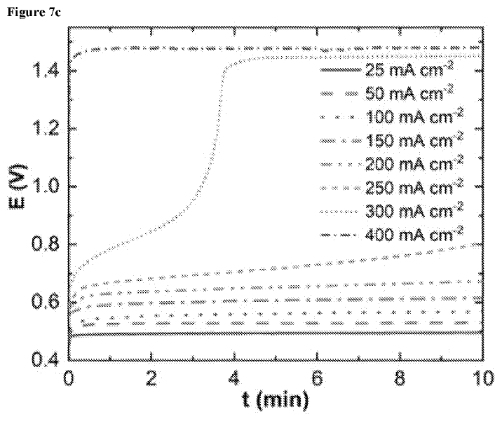

### FIG. 7a

FIG. 7a is a graph showing the 4^{th} scan of the CV curves of an alkali-alkali ammonia cracker with various Pt loading. 0.5 M NH₃ in 1M KOH was used as anolyte.

### FIG. 7b

FIG. 7b is a set of graphs showing the 4^{th} scan of the CV curves of an alkali-alkali ammonia cracker with various NH₃ concentrations. Pt loading was 2 mg cm⁻², with the anolyte further comprising 1 M KOH.

### FIG. 7c

FIG. 7c is a set of chronopotentiometry (CP) measurements of an alkali-alkali ammonia cracker at different current densities. Pt loading was 2 mg cm⁻², 0.5 M NH₃ in 1 M KOH was used as anolyte.

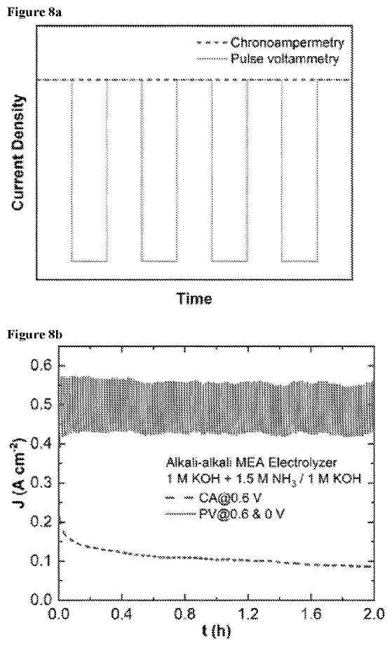

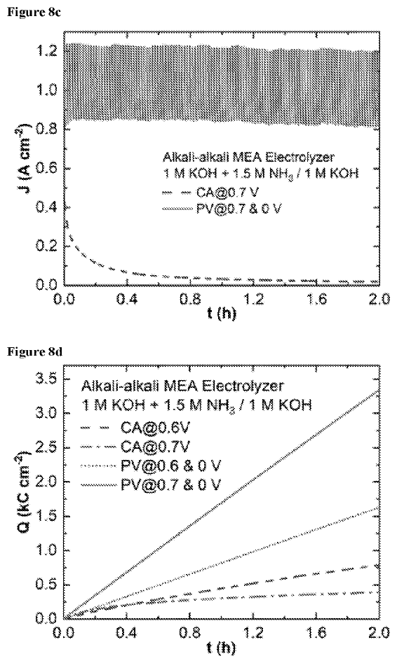

### FIG. 8a

FIG. 8a is a diagram showing the potential profiles used for chronoamperometry (CA) and pulse voltammetry (PV) tests.

### FIG. 8b

FIG. 8b shows the CA and PV curves of an alkali-alkali ammonia cracker when 0.6V is applied, with each step being 30 seconds, and the operating temperature being 80° C.

### FIG. 8c

FIG. 8c shows the CA and PV curves of an alkali-alkali ammonia cracker when 0.7V voltage is applied, with each step being 30 seconds, and the operating temperature being 80° C.

### FIG. 8d

FIG. 8d is a graph showing the corresponding charge of FIGS. 8b and 8c in the ammonia cracker.

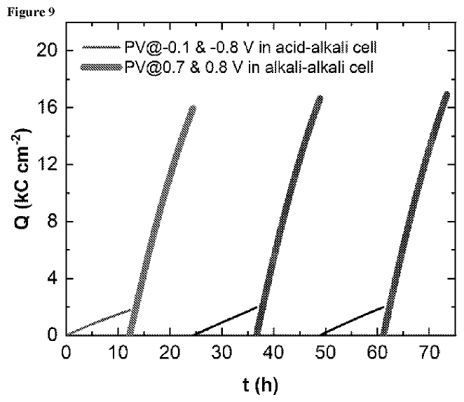

### FIG. 9

FIG. 9 is a graph showing the charges measured for the ammonia cracker when switching between the acid catholyte (0.5 M H₂SO₄) and alkali catholyte (1 M KOH). 0.5 M NH₃ in 1 M KOH was used as anolyte, operating durations were set at 30 seconds each step for the PV tests and 12 hours for each catholyte, and the operating temperature was 80° C.

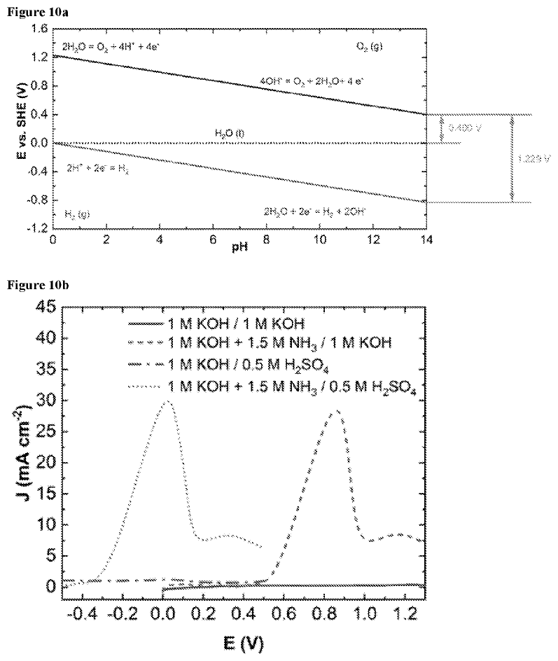

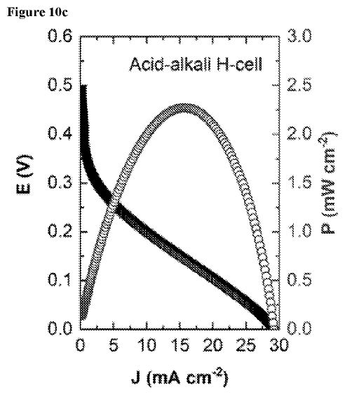

### FIG. 10a

FIG. 10a shows the Pourbaix diagram of water calculated by the Nernst equation showing the theoretical potentials for the OER and HER.

### FIG. 10b

FIG. 10b shows the LSV curves of AOR in alkali-alkali and acid-alkali H-cells. Electrode used was a glassy carbon electrode (GCE) drop casted with 0.2 mgₚₜ cm⁻² 40 wt % Pt/C.

### FIG. 10c

FIG. 10c shows the corresponding cell performance of the acid-alkali H-cell of FIG. 10b as a fuel cell in units of polarization and power density.

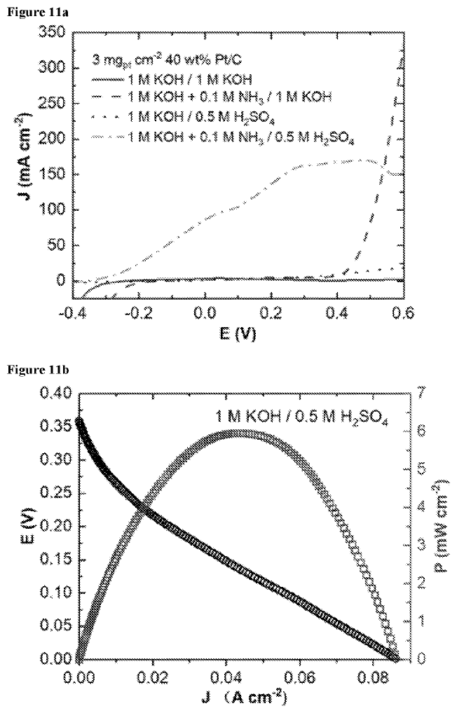

### FIG. 11a

FIG. 11a shows the LSV curves of AOR on 3 mgₚₜ cm⁻² 40 wt % Pt/C in alkali-alkali and acid-alkali H-cells.

### FIG. 11b

FIG. 11b shows the corresponding cell performance of the acid-alkali H-cell of FIG. 11a as a fuel cell in units of polarization and power density.

### DETAILED DESCRIPTION OF FIGURES

Referring to FIG. 4f, an anolyte comprising KOH and NH₃ is fed into an anode chamber by means of a pump. Catholyte containing either H₂SO₄ or KOH is fed from their respective catholyte chambers into the cathode chamber by means of a pump. A catholyte management system (not shown) may be included to control the flow of either the acid H₂SO₄ catholyte or the alkali KOH catholyte into the cathode chamber. An electric potential is applied across the electrodes, producing nitrogen from ammonia at the anode, and hydrogen from H₂SO₄ at the cathode. The anodic product comprising KOH, nitrogen and unreacted ammonia is pumped back into the anolyte chamber where the nitrogen product is separated from the anodic products, and fresh ammonia is pumped in to replace the spent ammonia. The cathodic product comprising either KOH and hydrogen, or H₂SO₄ and hydrogen are pumped back into their respective catholyte chambers, and the hydrogen product is separated from the cathodic products. Advantageously, this configuration allows for the switching between alkali catholyte and acid catholyte to the cathode chamber (and vice versa). By switching from alkali catholyte to an acid catholyte, the ammonia cracker of the present disclosure can generate both electricity and hydrogen concurrently. By switching to an acid catholyte, the electric potential needed to electrolyze ammonia is lower as compared to when an alkali catholyte is used, and thus advantageously saves on electricity and electricity bills, particularly during periods where electricity tariffs are higher. On the other hand, when switching to an alkali catholyte, the ammonia cracker of the present disclosure may require electricity to electrolyze ammonia and generate hydrogen, but can generate hydrogen at a far higher rate as compared to when an acid catholyte is used. Advantageously, the ammonia cracker can switch to an alkali catholyte to generate hydrogen when tariffs are low, and advantageously switch to an acid catholyte to still generate hydrogen without consuming any electricity when electricity tariffs are high.

### DETAILED DISCLOSURE OF EMBODIMENTS

Herein, the present invention provides electrochemical Ammonia Oxidation Reaction (AOR) as a solution for hydrogen production at low temperature and at ambient pressure. An ammonia cracker (which may also be referred to as an ammonia e-cracker) with AOR happening at the anode and Hydrogen Evolution Reaction (HER) at the cathode, and separated by an ion exchange membrane, is demonstrated herein and in the following examples.

The configuration of the ammonia cracker disclosed herein has surprisingly high current density and low overpotential due to minimal system resistance, while having enhanced mass transfer of the reaction due to flow convection.

In addition, the produced hydrogen is naturally separated from the other gaseous products (nitrogen, unreacted ammonia, other side gases) due to the configuration of the presently disclosed cracker. Thus, this results in minimal downstream separation and purification needed in order to obtain pure hydrogen for further applications.

In various examples disclosed herein, the performance of the AOR in the ammonia cracker surprisingly demonstrates a stable and industry-level current density of 0.22 and 0.47 A cm⁻² can be obtained during a pulse voltammetry test at the cell voltage of 0.6 & 0 V and 0.7 & 0 V (0.3 and 0.35 V on average).

In particular, a current density of 2.4 A cm⁻² may be achieved at a cell potential of 0.93 V from testing (FIG. 2d), and an average current density of 0.22 and 0.47 A cm⁻² can be obtained during a pulse voltammetry test at 0.6 & 0 V and 0.7 & 0 V (0.3 and 0.35 V on average) (FIG. 8c).

Further, an ammonia cracker using an acid-alkali setup is also disclosed. In this cracker, alkaline anolyte (containing ammonia) is pumped into the anode chamber, while an acidic catholyte is pumped into the cathode chamber. Consequently, a surprising reduction in electricity consumption can be observed. In particular, a cell voltage of only 76 mV is required to produce hydrogen at a current density of 100 mA cm⁻², which is a vast improvement over the alkali-alkali system.

Further, this ammonia cracker (acid-alkali configuration) can even be used as a fuel cell to generate both hydrogen and electricity at the same time. Accordingly, a highest power density of 5.9 mW cm⁻² can be achieved at a fuel cell voltage of 138 mV and current density of 43 mA cm⁻².

Considering the potentials required to achieve an industry-level current density of approximately 200 mA cm⁻² for AOR- and OER-assisted Hydrogen Evolution Reaction (HER) in literature are approximately 0.3 and 1.6 V respectively, the corresponding energy consumption to produce 1 kg hydrogen would therefore approximate to about 8.0 kWh and 42.9 kWh respectively. Hence, utilizing and maximizing the efficiency of the AOR in ammonia electrolysis will go far in increasing the attractiveness of ammonia as a hydrogen vector.

The present invention provides for an ammonia cracker comprising:
an anolyte chamber housing an anolyte, wherein the anolyte comprises alkali and ammonia;
a first catholyte chamber housing a first catholyte, wherein the first catholyte comprises alkali;
a second catholyte chamber housing a second catholyte, wherein the second catholyte comprises acid; and
an ammonia cracking cell, the electrolysis cell comprising:
   an anode chamber housing an anode;
   a cathode chamber housing a cathode; and
   an ion exchange membrane separating the anode chamber and the cathode chamber.

In some embodiments, the first catholyte chamber and second catholyte chamber are each fluidly connected to the cathode chamber. In further embodiments, the ammonia cracker comprises a catholyte management system for controlling flow of the first catholyte and second catholyte to the cathode chamber.

The anolyte chamber may be fluidly connected to the anode chamber. The connection may be via an anolyte flow channel. The first catholyte chamber may be fluidly connected to the cathode chamber. The connection may be via a first catholyte flow channel. The second catholyte chamber may be fluidly connected to the cathode chamber. The connection may be via a second catholyte flow channel.

In some other embodiments, the catholyte management system is programmed to switch flows to the cathode chamber from the first catholyte to the second catholyte after a predetermined set of parameters is fulfilled. In some embodiments, the catholyte management system is programmed to switch flows from the first catholyte to the second catholyte after a predetermined period of time. In some embodiments, the system is programmed to switch flows in response to demands in the hydrogen cell it is connected to. In some other embodiments, the system is programmed to switch flows in response to electricity demands in the electricity grid it is connected to.

The present invention also provides for an ammonia cracker comprising:
an anolyte chamber housing an anolyte, wherein the anolyte comprises alkali and ammonia;
a catholyte chamber housing an acid catholyte; and
an electrolysis cell, the electrolysis cell comprising:
   an anode chamber housing an anode;
   a cathode chamber housing a cathode; and
   an ion exchange membrane separating the anode chamber and the cathode chamber.

The present invention further provides for an ammonia cracker comprising:
an anolyte chamber housing an anolyte, wherein the anolyte comprises alkali and ammonia;
a catholyte chamber housing an alkali catholyte; and
an electrolysis cell, the electrolysis cell comprising:
   an anode chamber housing an anode;
   a cathode chamber housing a cathode; and
   an ion exchange membrane separating the anode chamber and the cathode chamber.

The anolyte chamber may be fluidly connected to the anode chamber. The connection may be via an anolyte flow channel. The catholyte chamber may be fluidly connected to the cathode chamber. The connection may be via a catholyte flow channel.

In some embodiments, the anode and/or cathode may be a gas diffusion electrode (GDE) comprising a Gas Diffusion Layer (GDL) as a substrate. In some embodiments, the GDE further comprises a catalyst layer coated on top of the GDL.

In some embodiments, the catalyst comprises 40 wt % Pt/C, Pt black and/or combinations thereof. In some embodiments, the catalyst further comprises binder ionomer. In some embodiments, the binder ionomer is an anion exchange ionomer. In some further embodiments, the binder ionomer is a Fumion FAA-3-SOLUT-10 ionomer.

In some embodiments the binder ionomer is present in the catalyst in a range of at least about 5 wt %; or from about 5 wt % to about 40 wt %, from about 5 wt % to about 35 wt %, from about 5 wt % to about 30 wt %, from about 5 wt % to about 25 wt %, from about 5 wt % to about 20 wt %, from about 5 wt % to about 15 wt %, from about 5 wt % to about 10 wt %; or from about 10 wt % to about 40 wt %, from about 15 wt % to about 40 wt %, from about 20 wt % to about 40 wt %, from about 25 wt % to about 40 wt %, from about 30 wt % to about 40 wt %, from about 35 wt % to about 40 wt %; or at most about 40 wt %; or about 5 wt %, about 10 wt %, about 15 wt %, about 20 wt %, about 25 wt %, about 30 wt %, about 35 wt %, about 40 wt %, or any ranges or values therebetween. In some embodiments, the catalyst comprises about 20 wt % binder ionomer.

In some embodiments, the catalyst loading is in the range of in a range of at least about 1 mg cm⁻²; or from about 1 mg cm⁻² to about 4 mg cm⁻², from about 1 mg cm⁻² to about 3.5 mg cm⁻², from about 1 mg cm⁻² to about 3 mg cm⁻², from about 1 mg cm⁻² to about 2.5 mg cm⁻², from about 1 mg cm⁻² to about 2 mg cm⁻², from about 1 mg cm⁻² to about 1.5 mg cm⁻²; or from about 1 mg cm⁻² to about 4 mg cm⁻², from about 1.5 mg cm⁻² to about 4 mg cm⁻², from about 2 mg cm⁻² to about 4 mg cm⁻², from about 2.5 mg cm⁻² to about 4 mg cm⁻², from about 3 mg cm⁻² to about 4 mg cm⁻², from about 3.5 mg cm⁻² to about 4 mg cm⁻²; or from about 1.5 mg cm⁻² to about 4 mg cm⁻², from about 2 mg cm⁻² to about 4 mg cm⁻², from about 2.5 mg cm⁻² to about 4 mg cm⁻², from about 3 mg cm⁻² to about 4 mg cm⁻², from about 3.5 mg cm⁻² to about 4 mg cm 2; or at most about 4 mg cm⁻²; or about 1 mg cm⁻², about 1.5 mg cm⁻², about 2 mg cm⁻², about 2.5 mg cm 2, about 3 mg cm⁻², about 3.5 mg cm⁻², about 4 mg cm⁻², or any ranges or values therebetween.

In some embodiments, the anode comprises a Pt-based catalyst. In other embodiments, the Pt-based catalyst is Pt/C (e.g., 40 wt % Pt/C) or Pt-black. In some embodiments, the anode GDL comprises Ni felt (also known as Ni fiber paper), Ni mesh, stainless steel felt, stainless steel mesh, Ti felt, Ti mesh, Pt-coated Ti felt, Pt-coated Ti mesh, and/or combinations thereof.

In some embodiments, the cathode comprises a Pt-based catalyst. In other embodiments, the Pt-based catalyst is Pt/C (e.g., 40 wt % Pt/C) or Pt-black. In some embodiments, the cathode GDL comprises carbon paper. In some embodiments, the cathode GDL comprises Toray carbon paper, Sigracet carbon paper, AvCarb carbon paper, Freudenberg carbon paper, or combinations thereof. In some embodiments, the carbon paper is a Toray 030 carbon paper, Toray 060 carbon paper, Toray 090 carbon paper, Toray 120 carbon paper, or combinations thereof.

In some embodiments, the ammonia cracker may comprise a membrane. The membrane may be an ion exchange membrane. The membrane may be a cation exchange membrane (CEM), an anion exchange membrane (AEM), and/or combinations thereof. In some other embodiments, the membrane is an AEM. In some embodiments, the AEM is a Sustainion AEM, Fumasep AEM, PiperION AEM, Alkymer AEM, or combinations thereof. In some embodiments, the AEM is a Sustainion X37-50 Grade T membrane.

In some embodiments, the electrode chamber comprises a bipolar plate. In some embodiments, the bipolar plate comprises a SS3161 block, a Pt-coated Ti plate, and/or combinations thereof.

In some embodiments, the alkali of the first catholyte or the alkali catholyte comprises KOH, NaOH, LiOH, CsOH, and/or combinations thereof. In further embodiments, the alkali of the catholyte is KOH.

In some embodiments, the hydroxide concentration in the first catholyte or the alkali catholyte is in a concentration range of at least about 0.1 M; or from about 0.1 M to about 6 M, from about 0.1 M to about 5.5 M, from about 0.1 M to about 5 M, from about 0.1 M to about 4.5 M, from about 0.1 M to about 4 M, from about 0.1 M to about 3.5 M, from about 0.1 M to about 3 M, from about 0.1 M to about 2.5 M, from about 0.1 M to about 2 M, from about 0.1 M to about 1.75 M, from about 0.1 M to about 1.5 M, from about 0.1 M to about 1.25 M, from about 0.1 M to about 1 M, from about 0.1 M to about 0.75 M, from about 0.1 M to about 0.5 M, from about 0.1 M to about 0.25 M, from about 0.1 M to about 0.2 M; or at most about 6 M; or from about 0.2 M to about 6 M, from about 0.25 M to about 6 M, from about 0.5 M to about 6 M, from about 0.75 M to about 6 M, from about 1 M to about 6 M, from about 1.25 M to about 6 M, from about 1.5 M to about 6 M, from about 1.75 M to about 6 M, from about 2 M to about 6 M, from about 2.5 M to about 6 M, from about 3 M to about 6 M, from about 3.5 M to about 6 M, from about 4 M to about 6 M, from about 4.5 M to about 6 M, from about 5 M to about 6 M, from about 5.5 M to about 6 M; or at most about 6 M; or about 0.1 M, about 0.2 M, about 0.25 M, about 0.5 M, about 0.75 M, about 1 M, about 1.25 M, about 1.5 M, about 1.75 M, about 2 M, about 2.5 M, about 3 M, about 3.5 M, about 4 M, about 4.5 M, about 5 M, about 5.5 M, about 6 M, or any ranges or values therebetween.

In some embodiments, the catholyte comprising the alkali or alkali catholyte may have a pH in a range of at least about 11; or from about 11 to about 14.6, from about 11 to about 14.5, from about 11 to about 14, from about 11 to about 13.5, from about 11 to about 13, from about 11 to about 12.5, from about 11 to about 12, from about 11 to about 11.5; or from about 11.5 to about 14.6, from about 12 to about 14.6, from about 12.5 to about 14.6, from about 13 to about 14.6, from about 13.5 to about 14.6, from about 14 to about 14.6, from about 14.5 to about 14.6, from about 11 to about 14.5; or at most about 14.6; or about 11, about 11.5, about 12, about 12.5, about 13, about 13.5, about 14, about 14.5, about 14.6, or any ranges or values therebetween.

In some embodiments, the acid of the second catholyte or the acid catholyte comprises H₂SO₄, HCl, HNO₃, HClO₄, and/or combinations thereof. In further embodiments, the acid of the catholyte is H₂SO₄.

In some embodiments, the proton concentration in the second catholyte or the acid catholyte is in a concentration range of at least about 0.1 M; or from about 0.1 M to about 6 M, from about 0.1 M to about 5.5 M, from about 0.1 M to about 5 M, from about 0.1 M to about 4.5 M, from about 0.1 M to about 4 M, from about 0.1 M to about 3.5 M, from about 0.1 M to about 3 M, from about 0.1 M to about 2.5 M, from about 0.1 M to about 2 M, from about 0.1 M to about 1.75 M, from about 0.1 M to about 1.5 M, from about 0.1 M to about 1.25 M, from about 0.1 M to about 1 M, from about 0.1 M to about 0.75 M, from about 0.1 M to about 0.5 M, from about 0.1 M to about 0.25 M, from about 0.1 M to about 0.2 M; or at most about 6 M; or from about 0.2 M to about 6 M, from about 0.25 M to about 6 M, from about 0.5 M to about 6 M, from about 0.75 M to about 6 M, from about 1 M to about 6 M, from about 1.25 M to about 6 M, from about 1.5 M to about 6 M, from about 1.75 M to about 6 M, from about 2 M to about 6 M, from about 2.5 M to about 6 M, from about 3 M to about 6 M, from about 3.5 M to about 6 M, from about 4 M to about 6 M, from about 4.5 M to about 6 M, from about 5 M to about 6 M, from about 5.5 M to about 6 M; or at most about 6 M; or about 0.1 M, about 0.2 M, about 0.25 M, about 0.5 M, about 0.75 M, about 1 M, about 1.25 M, about 1.5 M, about 1.75 M, about 2 M, about 2.5 M, about 3 M, about 3.5 M, about 4 M, about 4.5 M, about 5 M, about 5.5 M, about 6 M, or any ranges or values therebetween.

In some embodiments, the catholyte comprising the acid or acid catholyte may have a pH in a range of at least about −0.6; or from about −0.6 to about 2.5, from about −0.6 to about 2, from about −0.6 to about 1.5, from about −0.6 to about 1, from about −0.6 to about 0.5, from about −0.6 to about 0, from about −0.6 to about −0.5; or from about −0.5 to about 2.5, from about 0 to about 2.5, from about 0.5 to about 2.5, from about 1 to about 2.5, from about 1.5 to about 2.5, from about 2 to about 2.5; or at most about 2.5; or about −0.6, about −0.5, about 0, about 0.5, about 1, about 1.5, about 2, about 2.5 or any ranges or values therebetween.

In some embodiments, the anolyte comprises KOH, NaOH, LiOH, CsOH, and/or combinations thereof. In further embodiments, the anolyte comprises KOH.

In some embodiments, the hydroxide concentration in the anolyte is in a concentration range of at least about 0.1 M; or from about 0.1 M to about 6 M, from about 0.1 M to about 5.5 M, from about 0.1 M to about 5 M, from about 0.1 M to about 4.5 M, from about 0.1 M to about 4 M, from about 0.1 M to about 3.5 M, from about 0.1 M to about 3 M, from about 0.1 M to about 2.5 M, from about 0.1 M to about 2 M, from about 0.1 M to about 1.75 M, from about 0.1 M to about 1.5 M, from about 0.1 M to about 1.25 M, from about 0.1 M to about 1 M, from about 0.1 M to about 0.75 M, from about 0.1 M to about 0.5 M, from about 0.1 M to about 0.25 M, from about 0.1 M to about 0.2 M; or at most about 6 M; or from about 0.2 M to about 6 M, from about 0.25 M to about 6 M, from about 0.5 M to about 6 M, from about 0.75 M to about 6 M, from about 1 M to about 6 M, from about 1.25 M to about 6 M, from about 1.5 M to about 6 M, from about 1.75 M to about 6 M, from about 2 M to about 6 M, from about 2.5 M to about 6 M, from about 3 M to about 6 M, from about 3.5 M to about 6 M, from about 4 M to about 6 M, from about 4.5 M to about 6 M, from about 5 M to about 6 M, from about 5.5 M to about 6 M; or at most about 6 M; or about 0.1 M, about 0.2 M, about 0.25 M, about 0.5 M, about 0.75 M, about 1 M, about 1.25 M, about 1.5 M, about 1.75 M, about 2 M, about 2.5 M, about 3 M, about 3.5 M, about 4 M, about 4.5 M, about 5 M, about 5.5 M, about 6 M, or any ranges or values therebetween.

In some embodiments, the anolyte comprising alkali and ammonia may have a pH in a range of at least about 11; or from about 11 to about 14.6, from about 11 to about 14.5, from about 11 to about 14, from about 11 to about 13.5, from about 11 to about 13, from about 11 to about 12.5, from about 11 to about 12, from about 11 to about 11.5; or from about 11.5 to about 14.6, from about 12 to about 14.6, from about 12.5 to about 14.6, from about 13 to about 14.6, from about 13.5 to about 14.6, from about 14 to about 14.6, from about 14.5 to about 14.6, from about 11 to about 14.5; or at most about 14.6; or about 11, about 11.5, about 12, about 12.5, about 13, about 13.5, about 14, about 14.5, about 14.6, or any ranges or values therebetween.

In some embodiments, the concentration of the ammonia in the anolyte is in a range of at least about 0.1 M; or from about 0.1 M to about 3 M, from about 0.1 M to about 2.75 M, from about 0.1 M to about 2.5 M, from about 0.1 M to about 2.25 M, from about 0.1 M to about 2 M, from about 0.1 M to about 1.75 M, from about 0.1 M to about 1.5 M, from about 0.1 M to about 1.25 M, from about 0.1 M to about 1 M, from about 0.1 M to about 0.75 M, from about 0.1 M to about 0.5 M, from about 0.1 M to about 0.4 M, from about 0.1 M to about 0.3 M, from about 0.1 M to about 0.25 M, from about 0.1 M to about 0.2 M; or at most about 3 M; or from about 0.2 M to about 3 M, from about 0.25 M to about 3 M, from about 0.3 M to about 3 M, from about 0.4 M to about 3 M, from about 0.5 M to about 3 M, from about 0.75 M to about 3 M, from about 1 M to about 3 M, from about 1.25 M to about 3 M, from about 1.5 M to about 3 M, from about 1.75 M to about 3 M, from about 2 M to about 3 M, from about 2.25 M to about 3 M, from about 2.5 M to about 3 M, from about 2.75 M to about 3 M; or at most about 3 M; or about 0.1 M, about 0.2 M, about 0.25 M, about 0.3 M, about 0.4 M, about 0.5 M, about 0.75 M, about 1 M, about 1.25 M, about 1.5 M, about 1.75 M, about 2 M, about 2.25 M, about 2.5 M, about 2.75 M, about 3 M, or any ranges or values therebetween.

In some embodiments, the anolyte and second catholyte or acid catholyte have a pH difference in a range of at least about 7; or from about 7 to about 15, from about 7 to about 14.5, from about 7 to about 14, from about 7 to about 13.5, from about 7 to about 13, from about 7 to about 12.5, from about 7 to about 12, from about 7 to about 11.5, from about 7 to about 11, from about 7 to about 10.5, from about 7 to about 10, from about 7 to about 9.5, from about 7 to about 9, from about 7 to about 8.5, from about 7 to about 8, from about 7 to about 7.5; or from about 7 to about 14, from about 7.5 to about 14, from about 8 to about 14, from about 8.5 to about 14, from about 9 to about 14, from about 9.5 to about 14, from about 10 to about 14, from about 10.5 to about 14, from about 11 to about 14, from about 11.5 to about 14, from about 12 to about 14, from about 12.5 to about 14, from about 13 to about 14, from about 13.5 to about 14; or from about 7.5 to about 15, from about 8 to about 15, from about 8.5 to about 15, from about 9 to about 15, from about 9.5 to about 15, from about 10 to about 15, from about 10.5 to about 15, from about 11 to about 15, from about 11.5 to about 15, from about 12 to about 15, from about 12.5 to about 15, from about 13 to about 15, from about 13.5 to about 15, from about 14 to about 15, from about 14.5 to about 15; or at most about 15; or about 7, about 7.5, about 8, about 8.5, about 9, about 9.5, about 10, about 10.5, about 11, about 11.5, about 12, about 12.5, about 13, about 13.5, about 14, about 14.5, about 15, or any ranges or values therebetween.

In some embodiments, the ammonia cracker comprises separate outlets for anodic product and cathodic product. In some embodiments, the cathodic product comprises hydrogen.

The present invention discloses a method of producing hydrogen, the method comprising:
(i) feeding an anolyte comprising ammonia and alkali to an anode chamber housing an anode; and
(ii) feeding an alkali catholyte to a cathode chamber housing a cathode, wherein an ion exchange membrane separates the anode chamber and the cathode chamber.

The present invention discloses a method of producing hydrogen, the method comprising:
(i) feeding an anolyte comprising ammonia and alkali to an anode chamber housing an anode;
(ii) feeding an alkali catholyte to a cathode chamber housing a cathode; and
(iii) applying an electric potential between the anode and the cathode to activate electrolysis,
wherein an ion exchange membrane separates the anode chamber and the cathode chamber.

The present invention also discloses a method of producing hydrogen, the method comprising:
(i) feeding an anolyte comprising ammonia and alkali to an anode chamber housing an anode; and
(ii) feeding an acid catholyte to a cathode chamber housing a cathode,
wherein an ion exchange membrane separates the anode chamber and the cathode chamber.

In some embodiments, the method further comprises (iii-a) generating an electric potential when the acid catholyte is fed into the cathode chamber. In other embodiments, the method further comprises (iii-b) applying an electric potential between the anode and the cathode to activate electrolysis. In some other embodiments, the method further comprises (iii-a) generating an electric potential when the acid catholyte is fed into the cathode chamber, and/or (iii-b) applying an electric potential between the anode and the cathode to activate electrolysis.

The present invention also discloses a method of producing hydrogen, the method comprising:
(i-c) feeding an anolyte comprising ammonia and alkali to an anode chamber housing an anode;
(ii-c) feeding a first catholyte to a cathode chamber housing a cathode, wherein the first catholyte comprises alkali; and
(iii-c) switching from feeding a first catholyte to the cathode chamber to feeding a second catholyte to the cathode chamber after a predetermined period of time, wherein the second catholyte comprises acid,
wherein an ion exchange membrane separates the anode chamber and the cathode chamber.

The present invention also discloses a method of producing hydrogen, the method comprising:
(i) feeding an anolyte comprising ammonia and alkali to an anode chamber housing an anode;
(ii) feeding a first catholyte to a cathode chamber housing a cathode, wherein the first catholyte comprises alkali;
(iii) applying an electric potential between the anode and the cathode to activate electrolysis; and
(iv) switching from feeding a first catholyte to the cathode chamber to feeding a second catholyte to the cathode chamber after a predetermined period of time, wherein the second catholyte comprises acid,
wherein an ion exchange membrane separates the anode chamber and the cathode chamber.

The present invention also discloses a method of producing hydrogen, the method comprising:
(i-d) feeding an anolyte comprising ammonia and alkali to an anode chamber housing an anode;
(ii-d) feeding a second catholyte to a cathode chamber housing a cathode, wherein the second catholyte comprises acid; and
(iii-d) switching from feeding a second catholyte to the cathode chamber to feeding a first catholyte to the cathode chamber after a predetermined period of time, wherein the first catholyte comprises alkali,
wherein an ion exchange membrane separates the anode chamber and the cathode chamber.

The present invention also discloses a method of producing hydrogen, the method comprising:
(i-e) feeding an anolyte comprising ammonia and alkali to an anode chamber housing an anode;
(ii-e) feeding a second catholyte to a cathode chamber housing a cathode, wherein the second catholyte comprises acid;
(iii-e) switching from feeding a second catholyte to the cathode chamber to feeding a first catholyte to the cathode chamber after a predetermined period of time, wherein the first catholyte comprises alkali,
(iv-e) applying an electric potential between the anode and the cathode to activate electrolysis; and
wherein an ion exchange membrane separates the anode chamber and the cathode chamber.

By switching from alkali catholyte to acid catholyte, the ammonia cracker of the present disclosure can generate both electricity and hydrogen concurrently. Further, by switching to an acid catholyte, the electric potential needed to electrolyze ammonia is lower as compared to when an alkali catholyte is used, and thus advantageously saves on electricity and electricity bills, particularly during periods where electricity tariffs are higher. On the other hand, when switching to an alkali catholyte, the ammonia cracker of the present disclosure will require electricity to electrolyze ammonia and generate hydrogen, but can generate hydrogen at a far higher rate as compared to when an acid catholyte is used. Advantageously, the ammonia cracker can switch to an alkali catholyte to generate hydrogen when tariffs are low, and advantageously switch to an acid catholyte to still generate hydrogen without consuming any electricity when electricity tariffs are high. In particular, a current density of 100 mA cm⁻² can still be maintained at an extremely low cell voltage of 76 mV, while a highest power density of 5.9 mW cm⁻² may be achieved at the fuel cell voltage of 138 mV and current density of 43 mA cm⁻². Advantageously, this equates to an 85% energy efficiency as compared to when the ammonia cracker is run with the alkali catholyte.

In some embodiments, step (iii) or step (iv-e) comprises applying a constant electric potential to activate electrolysis. In some embodiments, step (iii) or step (iv-e) comprises applying a constant current density to activate electrolysis. In some other embodiments, step (iii) or step (iv-c) comprises applying a pulsed electric potential to activate electrolysis. In some embodiments, the pulsed electric potential is a squared waveform. In some other embodiments, the pulsed electric potential is a sinusoidal waveform. In some embodiments, the method further comprises applying a pulsed electric potential between the anode and cathode.

In some embodiments, an electric potential is instead generated when feeding the second catholyte or the acid catholyte to the cathode chamber compared to when feeding the first catholyte or the alkali catholyte to the cathode chamber.

The high operating temperature of the ammonia cracker (above room temperature to 90° C.) may advantageously reduce catalyst poisoning, and accordingly prolong its operation time.

In some embodiments, electric potential is generated when feeding the second catholyte or the acid catholyte to the cathode chamber. In some embodiments this electric potential generated is in a range of at least about 0.01 V; or from about 0.01 V to about 0.4 V, from about 0.01 V to about 0.375 V, from about 0.01 V to about 0.35 V, from about 0.01 V to about 0.325 V, from about 0.01 V to about 0.3 V, from about 0.01 V to about 0.275 V, from about 0.01 V to about 0.25 V, from about 0.01 V to about 0.225 V, from about 0.01 V to about 0.2 V, from about 0.01 V to about 0.175 V, from about 0.01 V to about 0.15 V, from about 0.01 V to about 0.138 V, from about 0.01 V to about 0.125 V, from about 0.01 V to about 0.1 V, from about 0.01 V to about 0.08 V, from about 0.01 V to about 0.076 V, from about 0.01 V to about 0.075 V, from about 0.01 V to about 0.07 V, from about 0.01 V to about 0.069 V, from about 0.01 V to about 0.05 V, from about 0.01 V to about 0.025 V; or from about 0.025 V to about 0.4 V, from about 0.05 V to about 0.4 V, from about 0.069 V to about 0.4 V, from about 0.07 V to about 0.4 V, from about 0.075 V to about 0.4 V, from about 0.076 V to about 0.4 V, from about 0.08 V to about 0.4 V, from about 0.1 V to about 0.4 V, from about 0.125 V to about 0.4 V, from about 0.138 V to about 0.4 V, from about 0.15 V to about 0.4 V, from about 0.175 V to about 0.4 V, from about 0.2 V to about 0.4 V, from about 0.225 V to about 0.4 V, from about 0.25 V to about 0.4 V, from about 0.275 V to about 0.4 V, from about 0.3 V to about 0.4 V, from about 0.325 V to about 0.4 V, from about 0.35 V to about 0.4 V, from about 0.375 V to about 0.4 V; or at most about 0.4 V; or about 0.01 V, about 0.025 V, about 0.05 V, about 0.069 V, about 0.07 V, about 0.075 V, about 0.076 V, about 0.08 V, about 0.1 V, about 0.125 V, about 0.138 V, about 0.15 V, about 0.175 V, about 0.2 V, about 0.225 V, about 0.25 V, about 0.275 V, about 0.3 V, about 0.325 V, about 0.35 V, about 0.375 V, about 0.4 V, or any values or ranges therebetween. In some embodiments, at most 0.4 V of electric potential is generated when feeding the second catholyte or the acid catholyte to the cathode chamber.

In some embodiments, a stable current density in long-term tests may be achieved using the method of the present invention, for example, a stable current density in a range of in a range of at least about 10 mA cm 2; or from about 10 mA cm⁻² to about 500 mA cm⁻², from about 10 mA cm⁻² to about 450 mA cm⁻², from about 10 mA cm⁻² to about 400 mA cm⁻², from about 10 mA cm⁻² to about 350 mA cm⁻², from about 10 mA cm⁻² to about 300 mA cm⁻², from about 10 mA cm⁻² to about 250 mA cm⁻², from about 10 mA cm⁻² to about 200 mA cm⁻², from about 10 mA cm⁻² to about 150 mA cm⁻², from about 10 mA cm⁻² to about 100 mA cm⁻², from about 10 mA cm⁻² to about 90 mA cm⁻², from about 10 mA cm⁻² to about 87 mA cm⁻², from about 10 mA cm⁻² to about 75 mA cm⁻², from about 10 mA cm⁻² to about 60 mA cm⁻², from about 10 mA cm⁻² to about 50 mA cm⁻², from about 10 mA cm⁻² to about 48 mA cm⁻², from about 10 mA cm⁻² to about 43 mA cm⁻², from about 10 mA cm⁻² to about 40 mA cm⁻², from about 10 mA cm⁻² to about 25 mA cm⁻², from about 10 mA cm⁻² to about 15.5 mA cm⁻²; or from about 15.5 mA cm⁻² to about 500 mA cm⁻², from about 25 mA cm⁻² to about 500 mA cm⁻², from about 40 mA cm⁻² to about 500 mA cm⁻², from about 43 mA cm⁻² to about 500 mA cm⁻², from about 48 mA cm⁻² to about 500 mA cm⁻², from about 50 mA cm⁻² to about 500 mA cm⁻², from about 60 mA cm⁻² to about 500 mA cm⁻², from about 75 mA cm⁻² to about 500 mA cm⁻², from about 87 mA cm⁻² to about 500 mA cm⁻², from about 90 mA cm⁻² to about 500 mA cm⁻², from about 100 mA cm⁻² to about 500 mA cm⁻², from about 150 mA cm⁻² to about 500 mA cm⁻², from about 200 mA cm⁻² to about 500 mA cm⁻², from about 250 mA cm⁻² to about 500 mA cm⁻², from about 300 mA cm⁻² to about 500 mA cm⁻², from about 350 mA cm⁻² to about 500 mA cm⁻², from about 400 mA cm⁻² to about 500 mA cm⁻², from about 450 mA cm⁻² to about 500 mA cm⁻²; or at most about 500 mA cm⁻²; or about 10 mA cm⁻², about 15.5 mA cm⁻², about 25 mA cm⁻², about 40 mA cm⁻², about 43 mA cm⁻², about 48 mA cm⁻², about 50 mA cm⁻², about 60 mA cm⁻², about 75 mA cm⁻², about 87 mA cm⁻², about 90 mA cm⁻², about 100 mA cm⁻², about 150 mA cm⁻², about 200 mA cm⁻², about 250 mA cm⁻², about 300 mA cm 2, about 350 mA cm⁻², about 400 mA cm⁻², about 450 mA cm⁻², about 500 mA cm⁻², or any ranges or values therebetween.

In some embodiments, the method is performed at a temperature range of at least about 20° C.; or from about 20° C. to about 90° C., from about 20° C. to about 80° C., from about 20° C. to about 70° C., from about 20° C. to about 60° C., from about 20° C. to about 50° C., from about 20° C. to about 40° C., from about 20° C. to about 30° C., from about 20° C. to about 25° C.; or from about 20° C. to about 90° C., from about 25° C. to about 90° C., from about 30° C. to about 90° C., from about 40° C. to about 90° C., from about 50° C. to about 90° C., from about 60° C. to about 90° C., from about 70° C. to about 90° C., from about 80° C. to about 90° C.; or from about 25° C. to about 90° C., from about 30° C. to about 90° C., from about 40° C. to about 90° C., from about 50° C. to about 90° C., from about 60° C. to about 90° C., from about 70° C. to about 90° C., from about 80° C. to about 90° C.; or at most about 90° C.; or about 20° C., about 25° C., about 30° C., about 40° C., about 50° C., about 60° C., about 70° C., about 80° C., about 90° C. Room temperature is typically 25° C.

In some embodiments, the method further produces electricity.

In some embodiments, the method produces an anodic product comprising nitrogen, and a cathodic product comprising hydrogen, from separate outlets.

The present invention also provides for hydrogen produced by any one of the methods disclosed herein.

### STATEMENTS OF INVENTION

1. An ammonia cracker comprising:
   an anolyte chamber housing an anolyte, wherein the anolyte comprises alkali and ammonia;
   a first catholyte chamber housing a first catholyte, wherein the first catholyte comprises alkali;
   a second catholyte chamber housing a second catholyte, wherein the second catholyte comprises acid; and
   an electrolysis cell, the electrolysis cell comprising:
      an anode chamber housing an anode;
      a cathode chamber housing a cathode; and
      an ion exchange membrane separating the anode chamber and the cathode chamber.
2. The ammonia cracker of statement 1, wherein the first catholyte chamber and second catholyte chamber are fluidly connected to the cathode chamber, and wherein the ammonia cracker further comprises a catholyte management system for controlling flow of the first catholyte and second catholyte to the cathode chamber.
3. The ammonia cracker of statement 2, wherein the catholyte management system is programmed to switch flows from the first catholyte to the second catholyte after a predetermined period of time.
4. The ammonia cracker of any one of statements 1 to 3, wherein the anolyte and second catholyte have a pH difference of at least about 10.
5. An ammonia cracker comprising,
   an anolyte chamber housing an anolyte, wherein the anolyte comprises alkali and ammonia;
   a catholyte chamber housing an acid catholyte; and
   an electrolysis cell, the electrolysis cell comprising:
      an anode chamber housing an anode;
      a cathode chamber housing a cathode; and
      an ion exchange membrane separating the anode chamber and the cathode chamber.
6. An ammonia cracker comprising,
   an anolyte chamber housing an anolyte, wherein the anolyte comprises alkali and ammonia;
   a catholyte chamber housing an alkali catholyte; and
   an electrolysis cell, the electrolysis cell comprising:
      an anode chamber housing an anode;
      a cathode chamber housing a cathode; and
      an ion exchange membrane separating the anode chamber and the cathode chamber.
7. The ammonia cracker of any one of statements 1 to 4 and 6, wherein the alkali of the first catholyte or alkali catholyte is selected from the group consisting of KOH or NaOH, LiOH, CsOH, and combinations thereof.
8. The ammonia cracker of any one of statements 1 to 5, wherein the acid of the second catholyte or acid catholyte is selected from the group consisting of H₂SO₄, HCl, HNO₃, and combinations thereof.
9. The ammonia cracker of any one of statements 1 to 8, wherein the anolyte comprises KOH, NaOH, LiOH, CsOH, or combinations thereof.
10. The ammonia cracker of any one of statements 1 to 9, wherein the anode and/or cathode comprises a Pt-based catalyst.
11. The ammonia cracker of any one of statements 1 to 10, wherein the Pt-based catalyst is 40 wt % Pt/C or Pt-black.
12. The ammonia cracker of any one of statements 1 to 11, wherein the anode further comprises Ni felt or Pt-coated Ti felt as Gas Diffusion Layers (GDLs).
13. The ammonia cracker of any one of statements 1 to 12, wherein the ammonia cracker comprises separate outlets for anodic product and cathodic product.
14. The ammonia cracker of any one of statements 1 to 13, wherein the cathodic product comprises hydrogen.
15. A method of producing hydrogen, the method comprising:
   (i) feeding an anolyte comprising ammonia and alkali to an anode chamber housing an anode;
   (ii) feeding a first catholyte to a cathode chamber housing a cathode, wherein the first catholyte comprises alkali;
   (iii) applying an electric potential between the anode and the cathode to activate electrolysis; and
   (iv) switching from feeding a first catholyte to the cathode chamber to feeding a second catholyte to the cathode chamber after a predetermined period of time, wherein the second catholyte comprises acid,
   wherein an ion exchange membrane separates the anode chamber and the cathode chamber.
16. A method of producing hydrogen, the method comprising:
   (i) feeding an anolyte comprising ammonia and alkali to an anode chamber housing an anode;
   (ii) feeding an alkali catholyte to a cathode chamber housing a cathode; and
   (iii) applying an electric potential between the anode and the cathode to activate electrolysis,
   wherein an ion exchange membrane separates the anode chamber and the cathode chamber.
17. A method of producing hydrogen, the method comprising:
   (i) feeding an anolyte comprising ammonia and alkali to an anode chamber housing an anode; and
   (ii) feeding an acid catholyte to a cathode chamber housing a cathode,
   wherein an ion exchange membrane separates the anode chamber and the cathode chamber.
18. The method of statement 15 or 17, wherein an electric potential is generated when feeding the second catholyte or the acid catholyte to the cathode chamber.
19. The method of any one of statements 15 to 18, wherein the method is performed at a temperature of about room temperature to about 90° C.
20. The method of any one of statements 15 and 17 to 19, further comprising applying a pulsed electric potential between the anode and the cathode.
21. The method of any one of statements 15 to 20, wherein the method produces an anodic product comprising nitrogen, and a cathodic product comprising hydrogen, from separate outlets.
22. Hydrogen produced by the method of any one of statements 15 to 21.

### EXAMPLES

Non-limiting examples of the invention and comparative examples will be further described in greater detail by reference to specific examples, which should not be construed as in any way limiting the scope of the invention.

### Material and Methods

The Sustainion X37-50 Grade T membrane was purchased from Dioxide Materials.

### Example 1: NH₃ Concentration

The effect of NH₃ concentration on the Ammonia Oxidation Reaction (AOR) was studied using a three-electrode system.

A glassy carbon electrode (GCE, diameter of 5 mm), a Hg/HgO electrode (1 M KOH) and a Pt plate were used as the working, reference and counter electrodes respectively. Catalyst ink was prepared by ultrasonicating 50 mg of 40 wt % Pt/C powder with 7.5 mL deionized water, 2.5 mL isopropanol, and 120 μL of 10 wt % FAA-3 ionomer solution for at least 1 hour. The working electrode (having a Pt mass loading of 1 mg cm⁻²) was prepared by drop-casting 100 μL of catalyst ink on the GCE, followed by overnight drying in a vacuum. Cyclic voltammetry (CV) tests were conducted at room temperature, at a scan rate of 10 mV s⁻¹ for 4 scans in 1 M KOH with ammonia concentrations of 0.25 M, 0.5 M, and 1 M. A control with 1 M KOH was also performed but at a different scan range.

As shown in FIG. 1, the anodic peaks were achieved at about 0.76 V vs. RHE, following which the anodic current density decreased with the increasing potential applied, likely due to catalyst poisoning by adsorbed N (N_{ad}) and adsorbed NO (NO_{ad}) intermediates. FIGS. 1(a)-(c) show the AOR peak current density decreasing more significantly at higher ammonia concentrations, suggesting that the higher ammonia concentration exacerbated the catalyst poisoning. As a result, as shown in FIG. 1(d), the AOR current density at an ammonia concentration of 0.5 M NH₃ was the highest in the 4th scan, reaching a peak current density of 60 mA cm⁻² at the applied potential of 0.76 V vs. RHE.

### Example 2: Ammonia Cracker

A Membrane Electrolyte Assembly (MEA) electrolyzers were assembled to further test the ammonia cracker (or ammonia e-cracker) of the present invention.

### Example 2a: Alkali-Alkali Ammonia Cracker

FIG. 4a shows a membrane electrode assembly (MEA) used for ammonia cracking in the present invention, FIG. 4b shows the cross-section of the same MEA, and FIG. 4f shows a schematic of the same MEA. As shown in FIG. 4a, the MEA comprises an anion exchange membrane (AEM) sandwiched by two gas diffusion layers (GDL) coated with catalysts. Two bipolar plates were employed as gas flow channels and current conductors to the GDLs. The catalyst ink was prepared by mixing 100 mg of 40 wt % Pt/C in the mixture of 15 mL isopropanol, 5 mL deionized water and 0.24 mL 10 wt % FAA-3 ionomer solution, followed by ultrasonication for at least one hour. The anode was prepared by air spraying the catalyst ink onto the nickel fiber paper with various Pt loading, and the cathode was prepared by air spraying the cathode catalyst ink (also Pt/C, with a loading of 1 mg cm⁻²) onto Toray 090 carbon paper on a hot plate at 90° C. For the AEM, a Sustainion X37-50 Grade T membrane was immersed in 1 M KOH solution for 24 hours to convert it to the hydroxide form, and used before drying to avoid membrane cracking. Stainless steel 3161 blocks with a single serpentine channel were used as bipolar plates. Viton gaskets with suitable thickness (0% and 25% compression for nickel fiber paper and carbon paper) were also placed to prevent the potential liquid/gas from leaking. The torque applied to assemble the cell was 8.5 Nm and the active area of the MEA was 4 cm². The cell temperature was maintained at 80° C. and the electrolyte was also preheated before being introduced into the cracker cell. Ar-saturated 1 M KOH electrolyte at various NH₃ concentrations was introduced into the cell with a flow rate of 2 mL min⁻¹. The ammonia cracker was first activated with chronopotentiometry at 0.1 A cm⁻² for 30 minutes prior to the subsequent tests.

KOH with NH₃ was pumped into the anode chamber, and 1 M KOH catholyte was pumped into the cathode chamber of the cell with a flow rate of 2 mL min⁻¹, respectively.

The following setup was used:

TABLE A

| | Alkali-alkali system |
|---|---|
| Anode catalyst | 3 mgₚₜ cm⁻² 40 wt % Pt/C on |
| | Ni fiber paper |
| Cathode catalyst | 1 mgₚₜ cm⁻² 40 wt % Pt/C on |
| | Toray 090 carbon paper |
| Anode bipolar plate | SS316L |
| Cathode bipolar plate | SS316L or (Pt-coated) Ti |
| | bipolar plate |
| Anolyte | 1M KOH + 1.5M NH₃ |
| Catholyte | 1M KOH |
| Membrane type | AEM |
| Temperature (° C.) | 80 |
| Flow rate (ml min⁻¹) | 2 |

### Example 2b: Acid-Alkali Ammonia Cracker

The same MEA from FIG. 4a was used, FIG. 4c shows the cross-section of the same MEA, and FIG. 4e shows a schematic of the same MEA. KOH with NH₃ was pumped into the anode chamber, and 0.5 H₂SO₄ catholyte was pumped into the cathode chamber of the cell with a flow rate of 2 mL min⁻¹, respectively.

The following setup was used:

TABLE B

| | Acid-alkali system |
|---|---|
| Anode catalyst | 3 mgₚₜ cm⁻² 40 wt % Pt/C on |
| | Ni fiber paper |
| Cathode catalyst | 1 mgₚₜ cm⁻² 40 wt % Pt/C on |
| | Toray 090 carbon paper |
| Anode bipolar plate | SS316L |
| Cathode bipolar plate | (Pt-coated) Ti bipolar plate |
| Anolyte | 1M KOH + 1.5M NH₃ |
| Catholyte | 0.5M H₂SO₄ |
| Membrane type | AEM |
| Temperature (° C.) | 80 |
| Flow rate (ml min−1) | 2 |

### Example 2c: Ammonia Cracker with “Switch”

The same MEA from FIG. 4a was used and FIG. 4f shows a schematic of the same MEA, but with two catholyte chambers. Anolyte comprising KOH and NH₃ is fed into an anode chamber by means of a pump. Catholyte containing cither H₂SO₄ or KOH is fed from their respective catholyte chambers into the cathode chamber by means of a pump. A catholyte management system (not shown) may be included to control the flow of either the acid H₂SO₄ catholyte or the alkali KOH catholyte into the cathode chamber. An electric potential is applied across the electrodes, producing nitrogen from ammonia at the anode, and hydrogen from H₂SO₄ at the cathode. The anodic product comprising KOH, nitrogen and unreacted ammonia is pumped back into the anolyte chamber where the nitrogen product is separated from the anodic products, and fresh ammonia is pumped in to replace the spent ammonia. The cathodic product comprising either KOH and hydrogen, or H₂SO₄ and hydrogen are pumped back into their respective catholyte chambers, and the hydrogen product is separated from the cathodic products. Advantageously, this configuration allows for the switching between alkali catholyte and acid catholyte to the cathode chamber (and vice versa). By switching from alkali catholyte to an acid catholyte, the ammonia cracker of the present disclosure can generate both electricity and hydrogen concurrently. By switching to an acid catholyte, the electric potential needed to electrolyze ammonia is lower as compared to when an alkali catholyte is used, and thus advantageously saves on electricity and electricity bills, particularly during periods where electricity tariffs are higher. On the other hand, when switching to an alkali catholyte, the ammonia cracker of the present disclosure may require electricity to electrolyze ammonia and generate hydrogen, but can generate hydrogen at a far higher rate as compared to when an acid catholyte is used. Advantageously, the ammonia cracker can switch to an alkali catholyte to generate hydrogen when tariffs are low, and advantageously switch to an acid catholyte to still generate hydrogen without consuming any electricity when electricity tariffs are high.

The following setup was used:

TABLE C

| | Acid-alkali system | Alkali-alkali system |
|---|---|---|
| Anode catalyst | 3 mgₚₜ cm⁻² 40 wt % Pt/C on | 3 mgₚₜ cm⁻² 40 wt % Pt/C on |
| | Ni fiber paper | Ni fiber paper |
| Cathode catalyst | 1 mgₚₜ cm⁻² 40 wt % Pt/C on | 1 mgₚₜ cm⁻² 40 wt % Pt/C on |
| | Toray 090 carbon paper | Toray 090 carbon paper |
| Anode bipolar plate | SS316L | SS316L |
| Cathode bipolar plate | (Pt-coated) Ti bipolar plate | SS316L or (Pt-coated) Ti |
| | | bipolar plate |
| Anolyte | 1M KOH + 1.5M NH₃ | 1M KOH + 1.5M NH₃ |
| Catholyte | 0.5M H₂SO₄ | 1M KOH |
| Membrane type | AEM | AEM |
| Temperature (° C.) | 80 | 80 |
| Flow rate (ml min⁻¹) | 2 | 2 |

### Example 3: Catalyst Loading

Cyclic Voltammetry tests were performed with the assembled ammonia cracker. The CV curves were achieved with a scan rate of 10 mV s⁻¹ while varying the anode catalyst loadings and ammonia concentrations.

FIGS. 5-6 shows the CV curves becoming stable from the second scan onwards, despite the different catalyst loadings and ammonia concentrations, suggesting that the catalyst poisoning was alleviated due to the high operating temperature.

FIGS. 5a-c shows the effect of varying Pt loading in the anode, while FIGS. 6a-d showed the effect of varying NH₃ concentrations in the anolyte. FIG. 7a compares the 4^{th} scans of the CV curves of the ammonia cracker with various anode catalyst loading (1, 2, 3 and 4 mg cm⁻² Pt) in 1 M KOH and 0.5 M NH₃ electrolyte. The results indicated that a Pt loading of 3 mg cm⁻² (using 40 wt % PVC as catalyst) resulted in the highest observed current density.

The CVs (4^{th} scans) in 1 M KOH electrolyte with different ammonia concentration (0.1, 0.25, 0.5 & 1 M) using the 2 mg cm⁻² anode Pt loading were then compared. From the results, it was observed that an ammonia concentration of 0.5 M resulted in the highest observed current density when 2 mg cm⁻² of 40 wt % Pt/C was used as catalyst.

It was observed from FIG. 5b that the highest anodic current density of 0.52 A cm⁻² could be achieved at a cell potential of 0.92 V at an NH₃ concentration of 0.5 M and 2 mg cm⁻² Pt loading.

### Example 4: Chronopotentiometry

To further validate the stability of the catalyst, chronopotentiometry tests with current densities from 25 mA cm⁻² to 400 mA cm⁻² were conducted. FIG. 7c shows that stable cell potentials could be obtained with current densities lower than 200 mA cm⁻² (0.67 V at 200 mA cm⁻²), and that the cell potential dramatically increased to the Oxygen Evolution Reaction (OER) region when the current density reached 300 mA cm⁻², suggesting the poisoning of the catalyst.

### Example 5: Voltage Waveforms

Based on the earlier chronopotentiometry (CP) tests, it was observed that maintaining a fixed current may potentially lead to ramping cell voltage due to the accumulation of catalyst poisoning. Therefore, the voltage waveform for ammonia cracking was studied. Chronoamperometry (CA) and Pulse Voltammetry (PV) tests were used to simulated constant voltage and pulsed voltage respectively.

From the CA and PV curves in FIGS. 8b-c, it was observed that the current density greatly improved when the PV method was used instead of the CA method. Two reasons are postulated here: (1) the diffusion layer thickness was reduced during the PV test, therefore enhancing the mass transfer; (2) the poisoned Pt catalyst could be regenerated at 0 V, therefore alleviating the catalyst poisoning effect of the AOR intermediates in long-duration tests.

FIG. 8d showed that PV had the most optimal operational parameters at 0.7 V (peak voltage) and 0 V (base voltage), and producing an ammonia cracking current density of 0.470 A cm⁻², equating to a hydrogen production rate of 17.5 mmol_{H2} cm⁻² h⁻¹. In view that a potential of 0.7 V was applied for half of the test (0 V for the rest half), the average applied potential was only 0.35 V, and therefore the electricity consumption for hydrogen production was 9.38 kWh per kg H₂, which approximated to a 75-80% energy consumption reduction as compared to hydrogen production from water splitting at the same current density. Besides, the energy efficiency calculated based on the Higher Heating Value (HHV) could reach ~85%, which is the highest theoretical adiabatic efficiency for thermocatalysis of ammonia cracking.

### Example 6: Acid Catholyte

It has been further discovered that by switching the alkali catholyte to an acid catholyte, a lower cell voltage is required to perform the AOR, through a phenomenon known as Electrochemical Neutralisation Energy (ENE). Electrochemically, the neutralization energy generated by mixing acid and alkali may be transferred to reduce required cell voltage, this value of the reduction may be calculated by the Nernstian equation as below.

For example, FIG. 10a explains how the ENE harvesting reduces the cell voltage of a water splitting cracker. According to the Nernst equation, the thermodynamic equilibrium potentials at 298 K and 1 atm for these two reactions can be presented by following equations:

$${E}_{O E R} = {E}_{OER}^{0} - \frac{R T}{nF} ln ( \frac{1}{{( {p}_{{O}_{2}} / {p}^{0} ) [ {H}^{+} ]}^{4}} ) = {E}_{OER}^{0} - 0.0148 \times l g ( \frac{1}{{p}_{{O}_{2}} / {p}^{0}} ) - 0.0 \; 592 \times pH$$

$${E}_{HER} = {E}_{HER}^{0} - \frac{R T}{n F} ln ( \frac{( {p}_{{H}_{2}} / {p}^{0} )}{{[ {H}^{+} ]}^{2}} ) = {E}_{HER}^{0} - 0.0296 \times l g ( ( {p}_{{H}_{2}} / {p}^{0} ) ) - 0.0 \; 592 \times pH$$

During HER, when pH values of the anolyte and catholyte are equal, the theoretical potential is 1.229 V. However, if the pH values of the anolyte and catholyte are 14 and 0 respectively, the theoretical potential is reduced to only 0.400 V. The same theoretical reduction in potential assisted by ENE can also be applied to the AOR, as the ammonia oxidation reaction is also a proton-coupled electron transfer reaction, and based on the Nernstian equation, the cell voltage can theoretically be reduced by up to 829 mV when the pH difference between the anolyte and catholyte is 14.

TABLE 1
Cell voltages at different current densities and the corresponding
energy consumption for electrochemical HER and AOR

| | | | | ΔGᵣ⁰ | E⁰ |
|---|---|---|---|---|---|
| Reactant | Reaction | Anolyte | Catholyte | (kJ mol⁻¹) | (V vs. RHE) |
| H₂O | Anode: 2OH⁻ → 1/2O₂ + H₂O + 2e⁻ | 1M KOH | 1M KOH | 237.2 | 1.23 |
| | Cathode: 2H₂O + 2e⁻ → H₂ + 2OH⁻ | | | | |
| | Overall: 2H₂O → H₂ + O₂ | | | | |
| NH₃ | Anode: 2NH₃ + 6OH⁻ → N₂ + 6H₂O + 6e⁻ | 1M KOH + | 1M KOH | 34.7 | 0.06 |
| | Cathode: H₂O + 2e⁻ → H₂ + 2OH⁻ | 1.5M NH3 | | | |
| | Overall: 2NH₃ → N₂ + 3H₂ | | | | |
| | | | 0.5M | −434.8 | −0.75 V |
| | | | H₂SO₄ | | |

| | U_{EC} (V) @ | Wₑ | U_{EC} (V) @ | Wₑ |
|---|---|---|---|---|
| Reactant | 0.1 A cm⁻² | (kWh/kg H₂) | 0.2 A cm⁻² | (kWh/kg H₂) |
| H₂O | 1.5 (cell | 40.2 | 1.6 (cell | 42.9 |
| | voltage in | | voltage in | |
| | CP tests) | | CP tests) | |
| NH₃ | 0.275 | 7.37 | 0.3 (average | 8.04 |
| | (average | | cell voltage | |
| | cell voltage | | in PV tests) | |
| | in PV tests) | | | |

| | | |
|---|---|---|
| approx. 48 mA cm⁻² was obtained | — | — |
| at 100 mV (cell voltage observed | | |
| in PV tests), equates to 4.8 mW | | |
| cm⁻² power density output, | | |
| and electricity output of | | |
| 2.68 kWh/kg H₂. | | |

The effect of ENE in the Ammonia Oxidation Reaction (AOR) was first investigated in a H-cell, comprising a glassy carbon electrode drop cast with 0.2 mgₚₜ cm⁻² 40 wt % Pt/C as working electrode, a Hg/HgO reference electrode and a Pt counter electrode. As shown in FIG. 10b, the peaks in the Linear Sweep Voltammetry (LSV) of the AOR shifted negatively by 831 mV when the anolyte was changed from 1 M KOH to 0.5 M H₂SO₄, which is close to the theoretical value of 829 mV mentioned above. FIG. 10c shows the cell performance of the AOR in a fuel cell, indicating that a maximum power density of 2.27 mW cm⁻² could be achieved at a current density of 15.5 mA cm⁻².

The effect of ENE was tested in the ammonia cracker of Example 2, using 40 wt % Pt/C as catalyst, a Pt loading of 3 mg cm⁻², and either 1 M KOH or 0.5 M H₂SO₄ as catholyte. The LSV curves were achieved with a scan rate of 10 mV s⁻¹ and are shown in FIG. 11a. A significant onset potential drop could be observed when 0.5 M H₂SO₄ was used as the catholyte as compared to when 1 M KOH was used as the catholyte, this effect is likely due to the ENE effect.

More specifically, to achieve a current density of 100 mV cm⁻², cell voltages of 520 mV and 76 mV were required for the alkali-alkali and acid-alkali ammonia crackers respectively, with the corresponding energy consumptions being 13.9 kWh/kg H₂ and 2.03 kWh/kg H₂. This also means an 85% savings in electricity consumption as compared to the alkali-alkali cracker system. Even at a cell voltage of 0 V, meaning no electricity input, a current density of 87 mA cm⁻² could still be obtained. This suggests the potential of simultaneous hydrogen generation and electricity production. FIG. 11b shows the cell performance of the acid-alkali ammonia cracker as a fuel cell. The power density curve suggests that a highest power density of 5.9 mW cm⁻² was achieved at a fuel cell voltage of 138 mV and current density of 43 mA cm⁻².

### Example 7: Switching Between Acid Catholyte and Alkali Catholyte

TABLE 2
Comparison of the ammonia cracker in the Alkali-Alkali and Alkali-Acid setup

| | Acid-alkali system | Alkali-alkali system |
|---|---|---|
| Anode catalyst | 3 mgₚₜ cm⁻² 40 wt % Pt/C on | 3 mgₚₜ cm⁻² 40 wt % Pt/C on |
| | Ni fiber paper | Ni fiber paper |
| Cathode catalyst | 1 mgₚₜ cm⁻² 40 wt % Pt/C on | 1 mgₚₜ cm⁻² 40 wt % Pt/C on |
| | Toray 090 carbon paper | Toray 090 carbon paper |
| Anode bipolar plate | SS316L | SS316L |
| Cathode bipolar plate | (Pt-coated) Ti bipolar plate | SS316L or (Pt-coated) Ti |
| | | bipolar plate |
| Anolyte | 1M KOH + 1.5M NH₃ | 1M KOH + 1.5M NH₃ |
| Catholyte | 0.5M H₂SO₄ | 1M KOH |
| Membranc typc | AEM | AEM |
| Temperature (° C.) | 80 | 80 |
| Flow rate (ml min⁻¹) | 2 | 2 |

Table 2 shows the parameters for the acid-alkali and alkali-alkali setups tested in the previous Examples. While the alkali-alkali system was able to crack ammonia at surprisingly high current densities and rate, the acid-alkali system was capable of cracking ammonia at higher efficiencies at lower current densities, as well as acting as a fuel cell to generate electricity while cracking ammonia.

A new cracker that can function in both the acid-alkali mode or the alkali-alkali mode would be advantageous and beneficial, since this cracker could crack ammonia to generate hydrogen and electricity (in the acid-alkali mode) during the day to avoid consuming electricity during the expensive peak-hour prices, while generating hydrogen at a faster rate (in the alkali-alkali mode) during the night time, where electricity prices are lower.

To achieve the benefits of both setups in a single cracker as mentioned above, a new cracker that includes both an acid catholyte and an alkali catholyte is proposed, as shown in FIG. 4f. The same ammonia cracker of Example 2 was used, except either KOH or H₂SO₄ as catholyte were pumped into the cathode chamber.

By means of a series of values (FIG. 4f), it is possible to switch between an acid or alkali catholyte to put the cracker in either the acid-alkali or alkali-alkali mode.

To test the feasibility of this “switching” cracker, PV tests were run at −0.1 V & −0.8 V for 12 hours in the acid-alkali cell mode, with 1.5 M NH₃/I M KOH as anolyte, and 0.5 M H₂SO₄ as catholyte, followed by PV at 0.7 V & 0 V for 12 hours in the alkali-alkali cell mode, with 1.5 M NH₃/I M KOH as anolyte, and 1 M KOH as catholyte. Results are shown in FIG. 9.

FIG. 9 showed that the switching PV tests exhibited satisfying reproducibility, with an average current density of 44.5 and 382 mV cm⁻² for acid-alkali and alkali-alkali cells respectively. This equates to hydrogen production rates of 1.66 and 14.2 mmol_{H2} cm⁻² h⁻¹ respectively over a period for 12 h. At the same time, in the acid-alkali mode, the cell could generate a power output of 4.45 mW cm⁻² over 12 h, further showing the feasibility of this “switching” cracker.

### Example 8: AOR Electrodes

To further improve AOR activity, different anode catalysts (Pt black, 40 wt % Pt/C), and different anode gas diffusion layers (GDLs) (Ni felt and Pt-coated Ti felt) were tested.

As shown in FIG. 2a, no AOR activity was observed when only Ni felt was present on the anode. Comparatively, some activity was observed when bare Pt-coated Ti felt was used as the anode, this activity could be attributed to the presence of Pt on the Ti felt.

Further, when 40 wt % Pt/C and Pt black were used with Ni felt as the GDL, there was no significant differences in AOR activity between the two catalysts. However, a slight increment in activity was observed when Ni felt was changed to Pt-coated Ti felt (while using 40 wt % Pt/C as the anode catalyst), this activity could be attributed to the Pt coating on the Ti felt being active towards AOR. Impressively, the increment in activity was much more significant when the Ni felt was changed to Pt-coated Ti felt (while using Pt black as the anode catalyst).

To understand the enhancement in performance, SEM tests were performed for the four types of gas diffusion electrodes (GDEs).

As shown in FIGS. 3b and 3d, the 40 wt % Pt/C catalyst was able to consistently form a uniform and dense catalyst layer, while FIGS. 3a and 3c shows that the Pt black catalyst could only be coated onto the fibers, leaving the pores of the felts uncovered. The uniform and dense catalyst layer formed by the 40 wt % Pt/C is expected to decrease the resistance, and therefore improving the kinetics for 40 wt % Pt/C on Ni felt (indicated by the larger LSV slope in the linear range at ~0.4-0.8 V) as compared to Pt black on Ni felt. The smaller Ni exposure as shown in FIGS. 3a-b does not affect its performance.

However, when Pt-coated Ti felt was used instead of the Ni felt, the Pt coating on the Ti felt exhibited AOR activity in the same range as 40 wt % Pt/C and Pt black, as shown in FIG. 2a. The Pt black catalyst layer formed on the Pt-coated Ti felt was less dense as compared to the 40 wt % Pt/C layer formed on the Pt-coated Ti felt, as shown in FIG. 3. This combination of Pt-coated Ti felt with Pt black resulted in a higher exposure of the Pt coating on the Ti felt to electrochemical oxidation reactions, or AOR in this instance (shown in FIGS. 3c-d), and thus enhances its AOR activity more significantly as compared to when Pt black was coated on Ni felt. Therefore, 3 mg cm⁻² Pt black on Pt-coated Ti felt was used as the anode GDE for the following tests.

The operational parameters of the AOR were further tested using Pt black on Pt-coated Ti felt as the new catalyst. FIGS. 2b-c shows that the AOR was most efficient using 1 M KOH+1.5 M NH₃ anolyte with a flow rate of 2 ml min⁻¹. It should also be noted that, although AOR activity increases with increasing KOH concentration up to 4 M (shown in FIG. 2d), 1 M KOH was used for the better stability of the anion exchange membrane (AEM).

In conclusion, the inventors have provided a novel and inventive ammonia cracker setup in the present invention to generate hydrogen by electrochemically cracking ammonia. The inventors have further discovered that using an acid catholyte further improves the efficiency of the ammonia cracker by utilizing the ENE. The acid-alkali ammonia cracker not only reduces the required cell voltage significantly, but also demonstrates the surprising capability of simultaneous hydrogen and electricity generation. Moreover, the hydrogen is produced separately from the nitrogen, residual ammonia and other side products, which additionally simplifies downstream hydrogen separation and purification. Further, the inventors have provided a new cracker that is capable of switching between an acid catholyte and an alkali catholyte, allowing for the ammonia cracker system to constantly generate hydrogen, while at the same time switching between an energy consuming electrochemical cell mode, or an energy generating fuel cell mode, allowing for the cracker to only consume electricity when the electricity demand is low (meaning cheaper electricity costs). Further, this also allows the ammonia cracker to generate and feed electricity back into the larger electricity grid as and when the need arises.

### INDUSTRIAL APPLICABILITY

The present invention relates to ammonia crackers for producing hydrogen. The ammonia crackers of the present invention are capable of cracking ammonia at low cell potentials, while maintaining industrial-level current densities. The ammonia crackers of the present invention are capable of generating hydrogen in a separate outlet stream from the other side-products, thus simplifying downstream purification and separation. The crackers of the present invention are capable of switching from a first catholyte to a second catholyte in the cathode chamber and thus are capable of either producing hydrogen while consuming electricity, or producing hydrogen and generating electricity concurrently. The crackers of the present invention also generate hydrogen at ambient temperatures and low pressures. Thus, this invention is capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. An ammonia cracker comprising:
an anolyte chamber housing an anolyte, wherein the anolyte comprises alkali and ammonia;
one of (a), (b) or (c) as follows:
(a) a first catholyte chamber housing a first catholyte, wherein the first catholyte comprises alkali;
a second catholyte chamber housing a second catholyte, wherein the second catholyte comprises acid;
(b) a catholyte chamber housing an acid catholyte; or
(c) a catholyte chamber housing an alkali catholyte, and
an electrolysis cell, the electrolysis cell comprising:
an anode chamber housing an anode;
a cathode chamber housing a cathode; and
an ion exchange membrane separating the anode chamber and the cathode chamber.

2. The ammonia cracker of claim 1, wherein in (a), the first catholyte chamber and second catholyte chamber are fluidly connected to the cathode chamber, and wherein the ammonia cracker further comprises a catholyte management system for controlling flow of the first catholyte and second catholyte to the cathode chamber.

3. The ammonia cracker of claim 2, wherein the catholyte management system is programmed to switch flows from the first catholyte to the second catholyte after a predetermined period of time.

4. The ammonia cracker of claim 1, wherein in (a), the anolyte and second catholyte have a pH difference of at least about 10.

5. (canceled)

6. (canceled)

7. The ammonia cracker of claim 1, wherein the alkali of the first catholyte or alkali catholyte is selected from the group consisting of KOH, NaOH, LiOH, CsOH, and combinations thereof.

8. The ammonia cracker of claim 1, wherein the acid of the second catholyte or acid catholyte is selected from the group consisting of H₂SO₄, HCl, HNO₃, and combinations thereof.

9. The ammonia cracker of claim 1, wherein the anolyte comprises KOH, NaOH, LiOH, CsOH, or combinations thereof.

10. The ammonia cracker of claim 1, wherein the anode and/or cathode comprises a Pt-based catalyst.

11. The ammonia cracker of claim 8, wherein the Pt-based catalyst is 40 wt % Pt/C or Pt-black.

12. The ammonia cracker of claim 1, wherein the anode further comprises Ni felt or Pt-coated Ti felt as Gas Diffusion Layers (GDLs).

13. The ammonia cracker of claim 1, wherein the ammonia cracker comprises separate outlets for anodic product and cathodic product.

14. The ammonia cracker of claim 1, wherein the cathodic product comprises hydrogen.

15. A method of producing hydrogen, the method comprising the steps of:
(i) feeding an anolyte comprising ammonia and alkali to an anode chamber housing an anode;
optionally, one of the following steps (ii-a) or (ii-b):
(ii-a) feeding a first catholyte to a cathode chamber housing a cathode, wherein the first catholyte comprises alkali; or
(ii-b) feeding an alkali catholyte to a cathode chamber housing a cathode;
if either step (ii-a) or step (ii-b) is present, then followed by step (iii):
(iii) applying an electric potential between the anode and the cathode to activate electrolysis;
if both steps (ii-a) and (iii) are present, then followed by step (iv):
(iv) switching from feeding a first catholyte to the cathode chamber to feeding a second catholyte to the cathode chamber after a predetermined period of time, wherein the second catholyte comprises acid,
if none of steps (ii-a), (ii-b), (iii) or (iv) are present, then followed by step (v):
(v) feeding an acid catholyte to a cathode chamber housing a cathode,
wherein an ion exchange membrane separates the anode chamber and the cathode chamber.

16. (canceled)

17. (canceled)

18. The method of claim 15, wherein an electric potential is generated when feeding the second catholyte or the acid catholyte to the cathode chamber.

19. The method of claim 15, wherein the method is performed at a temperature of about room temperature to about 90° C.

20. The method of claim 15, further comprising applying a pulsed electric potential between the anode and the cathode.

21. The method of claim 15, wherein the method produces an anodic product comprising nitrogen, and a cathodic product comprising hydrogen, from separate outlets.

22. Hydrogen produced by the method of claim 15.
